(19) United States
(12) Patent Application Publication
(10) Pub. No.: US 2012/0121411 A1
(43) Pub. Date: May 17, 2012

(54) Labyrinth Seals for Turbomachinery

(75) Inventors: Akira ENDO, Hitachinaka (JP); Kazuyuki YAMAGUCHI, Kasumigaura (JP); Yohei MAGARA, Mito (JP); Toyomi YOSHIDA, Kasumigaura (JP); Michiyuki TAKAGI, Ushiku (JP); Kenichi MURATA, Hitachi (JP); Takeshi KUDO, Hitachinaka (JP)

(73) Assignee: Hitachi, Ltd., Tokyo (JP)

(21) Appl. No.: 13/292,131

(22) Filed: Nov. 9, 2011

(30) Foreign Application Priority Data
Nov. 12, 2010 (JP) 2010-253376

(51) Int. Cl. F01D 11/00; F16J 15/447

(52) U.S. Cl. 415/229; 277/412

(57) ABSTRACT

A labyrinth seal is provided that can suppress the occurrence of an unequal pressure pattern in the seal, suppress unstable vibration of a rotating shaft and ensure sealing performance.

The labyrinth seal includes a seal ring 13 and a plurality of seal fins 11. Ring-like cavities 12 are defined on the outer circumference of the rotating shaft 2 with the seal ring 13 and the seal fins 11. The ring-like cavities 12 suppress a leakage flow LS moving along the outer circumference of the rotating shaft 2. Void portions 14 are each provided on the outer circumferential side of the cavity 12 in the seal ring 13 so as to extend in the circumferential direction of the rotating shaft 2 and communicate with the cavity 12 at circumferential intervals to temporarily relieve a leakage flow from inside the cavity in the circumferential direction.

### BACKGROUND OF THE INVENTION

1. Field of the Invention

The present invention relates to a labyrinth seal suitable for high-speed high-pressure turbomachinery such as steam turbines.

2. Description of the Related Art

Turbomachinery such as steam turbines is generally provided with a labyrinth seal between a rotating shaft and a casing housing the rotating shaft in order to prevent working fluid from leaking from the casing along the rotating shaft.

The labyrinth seal is generally provided with a plurality of seal fins in the axial direction of the rotating shaft with voids for pressure drop defined between the fins along the outer circumference of the rotating shaft. The labyrinth seal is designed so that the voids for pressure drop may allow a leakage flow moving in the seal to cause pressure losses which control the leakage flow, thereby exhibiting a sealing function.

The labyrinth seal designed as above has a possibility that the leakage flow moving in the seal may cause the unstable vibrations of the rotating shaft. More specifically, the leakage flow inside the labyrinth seal involves a circumferential flow in the same direction as the rotation of the rotating shaft due to an accompanying effect resulting from the rotation of the rotating shaft. This circumferential flow forms a high-pressure portion on the upstream side in the rotational direction with respect to the rotating shaft subjected to vibration displacement, thereby producing an unequal pressure pattern. The flow rate of the circumferential flow is more increased as the rotational speed of the rotating shaft is faster. The unequal pressure pattern produces fluid force in a direction perpendicular to the vibration displacement of the rotating shaft with strength depending on the flow rate. Therefore, high-pressure turbomachinery such as steam turbines is such that the fluid force acting in the direction perpendicular to the vibration displacement of the rotating shaft acts to whirl the rotating shaft in the rotational direction during high-speed rotation. As a result, since the vibration stability of the rotating shaft is lowered, unstable vibration may be occurred.

The problem with the unstable vibration of the rotating shaft with respect to such a labyrinth seal can be eliminated by controlling the unequal pressure pattern caused by the vibration displacement of the rotating shaft. Technologies disclosed in JP-8-319804-A and JP-58-152974-A are known as a technology for eliminating the unequal pressure pattern.

The labyrinth seal in JP-8-319804-A is formed with cavities or voids for pressure drop between seal fins. In addition, a seal ring is provided with a steam passage adapted to allow a high-pressure cavity to communicate with a low-pressure cavity. The steam passage is used to permit the leakage flow to partially escape out of the high-pressure cavity into the low-pressure cavity, thereby controlling the swirl flow of the leakage flow.

JP-58-152974-A discloses a technology for eliminating an unequal pressure pattern in a honeycomb seal. The honeycomb seal is provided with a circumferentially communicating space at a portion away from an opening end of the honeycomb seal. This space equalizes the circumferential unequal pattern of the pressure in a void for pressure drop, thereby suppressing the fluid force resulting from unstable vibration.

### SUMMARY OF THE INVENTION

The labyrinth structure disclosed in JP-8-319804-A described above is designed such that the steam passage extending in the axial direction of the rotating shaft is provided to allow the high-pressure cavity to communicate with the low-pressure cavity. Therefore, an amount of leakage toward the downstream side increases, which may probably lower sealing performance.

The honeycomb seal structure disclosed in JP-58-152974-A described above is designed as below. The cavities or voids for passage loss are provided with the space adapted to allow the cavities to circumferentially communicate with one another. In this way, the equalization of the circumferential pressure pattern can be achieved. On the other hand, the labyrinth seal is configured such that the cavities are already allowed to communicate with one another in the circumferential direction. Thus, this structure cannot be applied to the labyrinth seal.

The conventional technology described in JP-58-152974-A is designed such that the cavities communicate with one another also in the axial direction of the rotating shaft similarly to JP-8-319804-A. Therefore, there is a possibility that an amount of leakage is increased to lower the sealing performance. However, this point is not considered in the above conventional technology.

It is an object of the present invention to provide a labyrinth seal that can suppress the occurrence of an unequal pressure pattern in the seal, suppress unstable vibration of a rotating shaft and ensure sealing performance.

According to an aspect of the present invention, there is provided a labyrinth seal comprising: a seal ring installed between a rotor and a stator encircling the rotor and secured to the stator; a plurality of seal fins installed on the seal ring in an axial direction of the rotor so as to project in a radial direction of the rotor; ring-like cavities defined between the respective seal fins; and pressure relaxation means for allowing a leakage flow to temporarily escape out of the cavity toward an outer circumferential side of the cavity in a circumferential direction of the rotating shaft.

The labyrinth seal according to the aspect of the invention allows the leakage flow circulating in the cavity to temporarily escape toward the outer circumferential side of the cavity in the circumferential direction of the rotating shaft. This relieve pressure on the pressure rise portion in the cavity to suppress the occurrence of the unequal pressure pattern in the seal due to the pressure rise, which can suppress the unstable vibrations of the rotating shaft. In addition, sealing performance can be ensured.

### BRIEF DESCRIPTION OF THE DRAWINGS

FIG. 1 is a cross-sectional view illustrating an essential portion of a steam turbine.

FIG. 2 is an axial cross-sectional view of a labyrinth seal according to a first embodiment of the present invention.

FIG. 3 is a radial cross-sectional view of the labyrinth seal according to the first embodiment of the present invention.

FIG. 4 is a cross-sectional view taken along line X-X in FIG. 3.

FIG. 5 is a schematic diagram illustrating an in-cavity pressure pattern of a conventional labyrinth seal.

FIG. 6 is a schematic diagram illustrating an in-cavity pressure pattern of the labyrinth seal according to the first embodiment of the invention.

FIG. 7 is an axial cross-sectional view of a labyrinth seal according to a second embodiment of the present invention.

FIG. 8 is a radial cross-sectional view of the labyrinth seal according to a third embodiment of the present invention.

### DESCRIPTION OF THE PREFERRED EMBODIMENTS

Preferred embodiments of the present invention will hereinafter be described with reference to the drawings.

### First Embodiment

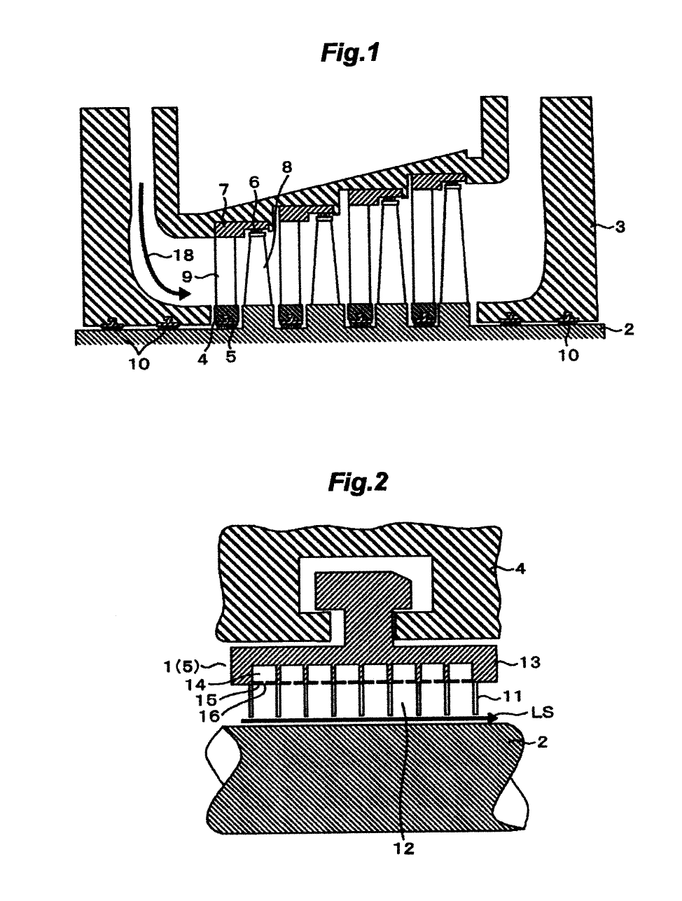

A first embodiment of the present invention is described with reference to FIGS. 1 to 6. The present embodiment is one in which the present invention is applied to a labyrinth seal used for a steam turbine.

A description is first given of an essential structure of the steam turbine embodying the present invention.

FIG. 1 is a cross-sectional view illustrating one example of the essential structure of the general steam turbine.

In FIG. 1, there are shown a rotating shaft 2, a rotor casing 3, a nozzle diaphragm inner ring 4, a diaphragm packing 5, a tip fin 6, a nozzle diaphragm outer ring 7, a moving blade 8, a nozzle 9 and a shaft packing 10.

The steam turbine mainly includes the rotating shaft 2 constituting a rotor along with the moving blades 8, and the rotor casing 3 which is a stator, encloses and holds the rotating shaft 2 and forms a passage for steam 18 or working fluid. A plurality of the moving blades 8 are circumferentially secured to the rotating shaft 2. In addition, a plurality of the nozzles 9 are circumferentially secured to the rotor casing 3 so as to face the upstream side of the respective moving blades 8 in the steam-flowing direction. The nozzle 9 has an outer circumferential end secured to the nozzle diaphragm outer ring 7 that is secured to the rotor casing 3 and has an inner circumferential end secured to the nozzle diaphragm inner ring 4. In the steam turbine, the moving blade 8 and the nozzle 9 installed to face the upstream side of the moving blade 8 constitute a stage such that a plurality of the stages are installed in the axial direction of the rotating shaft 2.

When passing the nozzle 9, steam 18 or working fluid is accelerated to be sent to the moving blade 8 at which velocity energy thereof is converted into kinetic energy to rotate the rotating shaft 2. The rotating shaft 2 is connected to a power generator not shown in which the output power is taken out as electric energy.

A clearance is defined between the rotating shaft 2 or the rotor and the rotor casing 3 or the stator in such a manner as not to interfere with the rotation of the rotating shaft 2. A portion of the steam 18 flows out as a leakage flow from the clearance. The leaking steam is not effectively utilized for the rotational movement of the rotating shaft 2; therefore, it contributes to lower steam turbine efficiency.

To avoid the lowering steam turbine efficiency, a sealing device such as a labyrinth seal is provided at the clearance portion between the rotating shaft 2 or the rotor and the rotor casing 3 or the stator so as to prevent the steam from flowing out therefrom.

For example, a labyrinth seal is used for the diaphragm packing 5, the tip fin 6, and the shaft packing 10. The diaphragm packing 5 is adapted to prevent the leakage of steam from the clearance between the nozzle diaphragm inner ring 4 and the rotating shaft 2. The tip fin 6 is adapted to prevent the leakage of steam from the clearance between the moving blade 8 and the rotor casing 3. The shaft packing 10 is adapted to prevent the leakage of steam from the clearance between the rotating shaft 2 and the rotor casing 3.

The labyrinth seal has a plurality of the seal fins 11 projecting in the radial direction of the rotating shaft from at least one of the rotor and the stator. In addition, voids for pressure drop (cavities 12) are defined between the seal fins along the outer circumference of the rotating shaft 2. The labyrinth seal is designed such that the void for pressure drop allows the leakage flow moving toward the downstream side in the seal to cause a pressure loss, thereby suppressing the leakage flow to exhibit a sealing function.

However, the conventional labyrinth seal has a problem as below.

FIG. 5 is a schematic diagram illustrating an in-cavity pressure pattern of the conventional labyrinth seal.

In general, an axial turbine such as a steam turbine has an accompanying effect due to the rotation of the rotating shaft 2. The accompanying effect rotates also a leakage flow in the rotational direction R of the rotating shaft 2 to produce a circumferential flow RS. If the rotating shaft 2 is eccentric in one direction (vibration displacement), the cavity 12 is narrowed in an eccentric direction. The circumferential flow RS is held back on the upstream side in the eccentric direction of the rotating shaft 2 to produce a high-pressure portion. On the contrary, the circumferential flow RS allows fluid to escape on the downstream side in the eccentric direction of the rotating shaft 2 to reduce in pressure. This unequal pressure pattern P produces fluid force, which presses the rotating shaft 2 in the circumferential direction R. Thus, the rotating shaft 2 whirls to cause unstable vibrations.

A description is next given of a labyrinth seal of the present embodiment taking into consideration the problem with the conventional labyrinth seal as described above.

The present embodiment is one in which the present invention is applied to a labyrinth seal used for the diaphragm packing 5, as one of the embodiments in which the invention is applied to labyrinth seals used in a steam turbine.

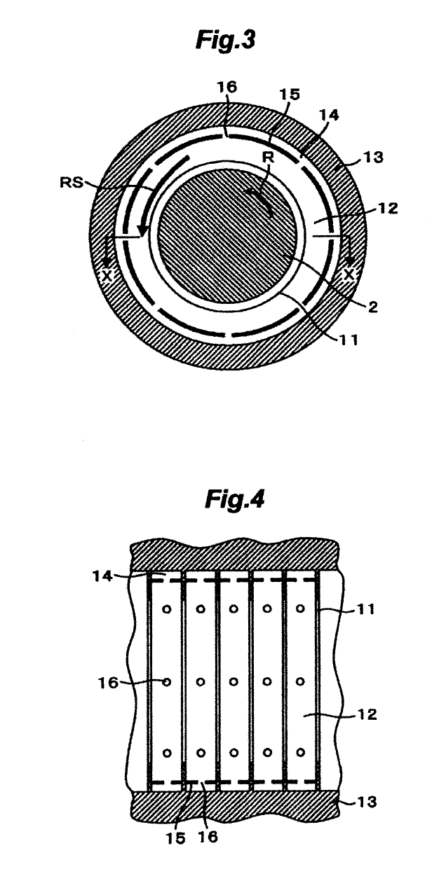

FIG. 2 is an axial cross-sectional view of the labyrinth seal 1 according to the first embodiment. FIG. 3 is a radial cross-sectional view of the labyrinth seal 1 according to the first embodiment. FIG. 4 is a cross-sectional view of the labyrinth seal 1 according to the first embodiment, taken along line X-X in FIG. 3.

Referring to FIG. 2, the labyrinth seal 1 includes a seal ring 13 and seal fins 11. The seal ring 13 is a member assembled like a ring formed along the circumferential direction of the rotating shaft 2 and is secured to the nozzle diaphragm inner ring 4. A plurality of the seal fins 11 are axially installed on the inner circumferential side wall surface of the seal ring 13 so as to project toward the inner circumferential side in the radial direction of the rotating shaft. The seal fin 11 is a thin plate-like member extending along the outer circumference of the rotating shaft 2 toward the circumferential direction as shown in FIG. 3. In addition, the seal fin 11 is secured to the seal ring 13 so as to face the rotating shaft 2 with a radial clearance defined therebetween.

As illustrated in FIGS. 2 and 3, the labyrinth seal 1 is formed with cavities 12, which are ring-like voids for pressure drop, between the seal ring 13 and the seal fins 11 along the outer circumference of the rotating shaft 2.

The cavities 12 form a single space not divided in the circumferential direction. These cavities 12 serve as a void for pressure drop, which allows a leakage flow to cause a pressure loss when the leakage flow passes therethrough. Thus, the labyrinth seal 1 suppresses the leakage flow LS, exhibiting a sealing function.

As illustrated in FIG. 2, in the present embodiment void portions 14 are provided at positions corresponding to the outer circumferences of the cavities 12, in the seal ring 13. As illustrated in FIG. 3, the void portion 14 is an annular void extending along the cavity 12 in the circumferential direction. The void portion 14 is formed on the outer circumference of each of the plurality of cavities 12 formed in the axial direction. The void portions 14 are independent spaces not communicating with each other.

As illustrated in FIGS. 2 and 3, the void portion 14 is composed of a groove and a ring-like plate 15. The groove is formed on an inner circumferential surface corresponding to the bottom position of the cavity 12 so as to extend in the circumferential direction. The ring-like plate 15 is located at the bottom position of the cavity 12 so as to block the opening portion of the groove. The plate 15 radially divides the cavity 12 and the void portion 14 from each other in the radial direction.

FIG. 4 is a cross-sectional view taken along line X-X in FIG. 3. FIG. 4 omits the illustration of the rotating shaft 2 for explanation. As illustrated in FIG. 4, the cavities 12 are each formed between the seal fins 11 and plates 15 are each provided at the respective bottoms of the cavities 12.

The plates 15 are each formed, in the circumferential direction thereof, with a plurality of through-holes 16 as communication means for allowing the cavity 12 and the void portion 14 to communicate with each other. More specifically, as illustrated in FIG. 4, in the present embodiment the through-holes 16 are provided in each plate 15 at eight positions at circumferentially regular intervals. The through-holes 16 provided in each plate 15 are axially arranged in a straight line so as to be in a coordinate phase. Incidentally, the present embodiment is just one example and the positions of the through-holes 16 are not limited to eight.

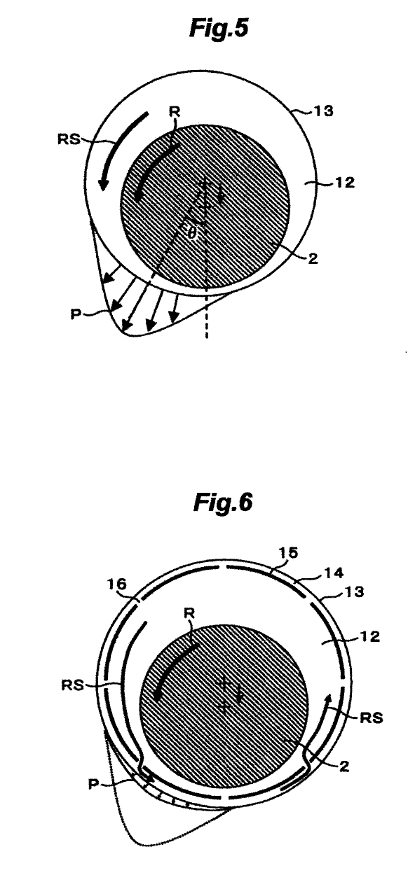

The function and effect of the present invention are next described by use of FIG. 6. In FIG. 6, a broken line indicates a conventional circumferential pressure pattern.

As shown in FIG. 6, even if the rotating shaft 2 is eccentric to allow the leakage flow circulating in the cavity to be partially blocked at the high-pressure portion, the fluid flows into the void portion 14 from the cavity 12 via the through-hole 16. The leakage flow having been blocked at the high-pressure portion in the past can be permitted to escape into the void portion 14. Therefore, the pressure on the high-pressure portion can be allowed to escape and relaxed to suppress a pressure rise.

The leakage flow moving into the void portion 14 flows toward the circumferential low-pressure portion in the void portion 14. Fluid flows out from the void portion 14 via the through-holes 16 into the cavity 12 to increase the pressure in the low-pressure portion. Moving in and out of fluid between the void 14 and the cavity 12 equalizes the circumferential pressure pattern. Thus, the fluid force due to the unequal pressure pattern can be reduced.

In the present embodiment, even if the rotating shaft 2 is eccentric to allow the leakage flow circulating in the cavity to be partially blocked at the high-pressure portion, the leakage flow can temporarily escape out of the cavity 12 toward the outer circumferential side of the cavity 12 via the void portion 14 in the circumferential direction of the rotating shaft 2. As a result, the unstable vibrations due to the unequal pressure pattern in the cavity 12 can be suppressed more satisfactorily.

Since the unstable vibrations of the rotating shaft 2 are whirling, it is preferred that the two through-holes 16 serving as the entrance and exit for fluid be arranged at circumferentially equal intervals so as to reduce the fluid force even if the rotating shaft 2 is eccentric in any direction. Preferably, the arrangement angle of the through-holes 16 serving as the entrance and exit for fluid be provided with the holes spaced from each other in a range from 60° to 180°.

The labyrinth seal 1 is short relative to the total length of the rotating shaft 2; therefore, the eccentric direction of the rotating shaft 2 is the same for any of the cavities 12. To reduce the fluid force more effectively, it is desired that the through-holes 16 be arranged in the coordinate phase in the circumferential direction of each cavity 12.

In the present embodiment, the void portions 14 are independently provided on the outer circumferential side of the plurality of cavities 12 provided in the axial direction and do not communicate with each other in the axial direction. Therefore, the leakage flow moving in from the upstream side cavity 12 will not flow out to the downstream side cavity 12 via the void portion 14. Thus, an amount of leakage will not increase, not leading to lower sealing performance.

Because of the above, the labyrinth seal 1 of the present embodiment can equalize the unequal pressure pattern to effectively eliminate the unstable vibrations of the rotating shaft 2 while ensuring the sealing performance.

In the present embodiment, the through-hole 16 is formed in a circular hole as shown in FIG. 4; however, it may be shaped in a quadrangle or a triangle, or like a slit, etc.

The shape of the through-hole 16 may not be parallel in the radial direction. The shape of the through-hole 16 may be formed in a convergence or divergence from the cavity 12 toward the void portion 14.

The void portions 14 are arranged for all the cavities 12. However, the void portions 14 are not necessarily arranged for all the cavities 12. The number of the through-holes 16 may be two or more.

The present embodiment is described by use of the example in which the present invention is applied to the labyrinth seal used for the diaphragm packing 5. However, the present invention can similarly be applied to the case where the labyrinth seal is used for the shift packing 10 or the tip fin 6.

### Second Embodiment

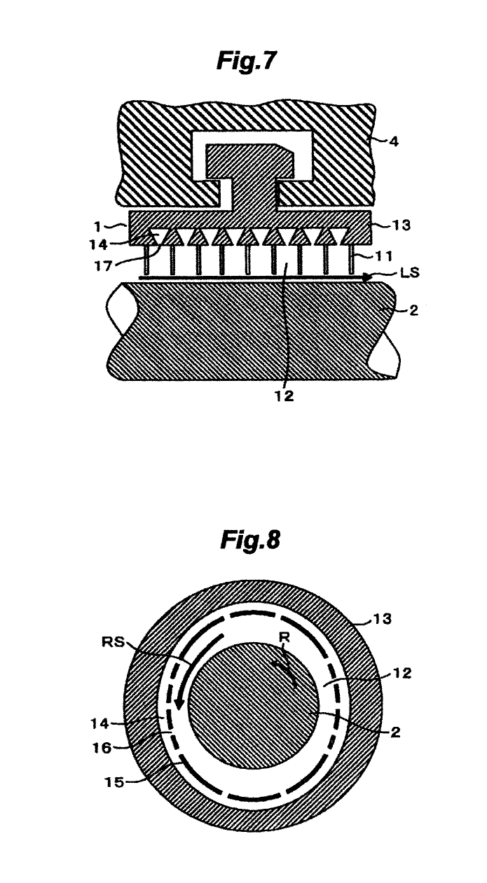

A description is next given of a second embodiment of the present invention. FIG. 7 is an axial cross-sectional view of a labyrinth seal according to a second embodiment of the present invention. The same constitutional elements as those in the first embodiment are denoted with like reference numerals and their explanations are omitted.

In the first embodiment described earlier, the void portion 14 corresponding to each of the cavities 12 is formed in a quadrangle in axial cross-section. On the other hand, in the present embodiment, the void portion 14 is formed in a convergent shape, in axial cross-section, toward the corresponding cavity 12 and the plate 15 is not provided. Since the axial cross-sectional shape of the void portion 14 is formed in a convergent shape, a communicating portion (a convergent portion) of the void portion 14 with the cavity 12 is formed like a circumferentially communicating slit. This slit 17 sufficiently restricts the communicating portion between the cavity 12 and the void portion 14. Therefore, the void portion 14 is internally less susceptible to the circumferential flow RS. The void portion 14 of the present embodiment can easily be obtained by counterbore machining in the outer circumferential direction from the cavity 12 side.

Also the structure of the present embodiment can temporarily release the leakage flow from inside the cavity 12 toward the outer circumferential side of the cavity 12 in the circumferential direction of the rotating shaft 2 via the void portion 14. Therefore, while ensuring sealing performance similarly to the first embodiment, the present embodiment can equalize the unequal pressure pattern, thereby effectively eliminating the unstable vibrations of the rotating shaft 2.

Additionally, the present embodiment can save the trouble of installing the plate 15, thereby facilitating machining.

In the present embodiment, the axial cross-sectional shape of the void portion 14 is triangular. However, the axial cross-sectional shape of the void portion 14 may be other shapes as long as they have a convergent shape toward the cavity 12 side.

### Third Embodiment

A description is given of a third embodiment of the present invention. FIG. 8 is a radial cross-sectional view of a labyrinth seal 1 according to the third embodiment of the present invention. The same constituent elements as those in the first embodiment are denoted with like reference numerals and their explanations are omitted.

In the present embodiment, the cavity 12 has a circumferentially non-uniform depth (the distance from the outer circumference of the rotating shaft 2 to the inner circumference of the seal ring 13). Specifically, the depth of the cavity 12 has a large depth in the vertical direction and a small depth in the horizontal direction. Such a labyrinth seal is sometimes used in turbomachinery whose rotating shaft 2 has a large vertical displacement. When the rotating shaft 2 is eccentric, a pressure rise in a high-pressure portion is increased more in the horizontal direction in which the cavity 12 has a small depth, which increases the unequal pressure pattern.

In the first embodiment described earlier, the through-holes 16 are circumferentially provided at regular intervals. On the other hand, in the present embodiment, the through-holes 16 are provided more in the horizontal direction in which a large pressure rise occurs inside the cavity 12 when the rotating shaft 2 is eccentric, than in the vertical direction. This can suppress the local pressure pattern of the circumferential flow RS. Therefore, the labyrinth seal 1 of the present embodiment can more effectively release pressure in the direction in which a large pressure rise occurs. Thus, the unstable vibrations of the rotating shaft 2 due to the circumferential flow RS can be eliminated more effectively.

Incidentally, the present invention is not limited to the embodiments described above and includes various examples of the shape. The above-embodiments are described in detail in order to give clear explanation of the present invention. The present invention is not necessarily limited to the embodiments provided with all the described configurations.

The above-embodiments are described taking the steam turbine as an example. However, the present invention is not limited to this but can be applied to other turbomachinery, e.g., a centrifugal compressor or the like.

What is claimed is:

1. A labyrinth seal comprising:
a seal ring installed between a rotor and a stator encircling the rotor and secured to the stator;
a plurality of seal fins installed on the seal ring in an axial direction of the rotor so as to project in a radial direction of the rotor;
ring-like cavities defined between the respective seal fins installed in the axial direction; and
a pressure relaxation structure for allowing a leakage flow to temporarily escape out of the cavity toward an outer circumferential side of the cavity in a circumferential direction of the rotating shaft.

2. The labyrinth seal according to claim 1,
wherein the pressure relaxation structure is a void portion provided on the outer circumferential side of the cavity so as to extend in the circumferential direction of the rotor and communicating with the cavity at a plurality of positions spaced circumferentially apart from each other.

3. The labyrinth seal according to claim 2,
wherein the void portion is formed of a groove provided in an inner circumferential surface of the seal ring at a bottom position of the cavity and a plate provided at the bottom of the cavity to block an opening portion of the groove, and
the plate is provided with communicating means along the circumferential direction of the rotor, the communicating means allowing the cavity and the void portion to communicate with each other.

4. The labyrinth seal according to claim 3,
wherein the communicating means is a plurality of through-holes provided along the circumferential direction of the rotor, and
the through-holes are circumferentially arranged at regular intervals.

5. The labyrinth seal according to claim 4,
wherein the cavities are provided a plurality of numbers in the axial direction of the rotor,
the void portion is provided on the outer circumferential side of each of the cavities provided in the axial direction of the rotor, and
positions of the through-holes provided in the plate for each of the cavities are arranged in a coordinate phase in the circumferential direction.

6. The labyrinth seal according to claim 3,
wherein the cavity is formed to have a smaller depth in a horizontal direction of the stator than in a vertical direction of the stator, and
the communicating means is through-holes that are provided more in the horizontal direction than in the vertical direction.

7. The labyrinth seal according to claim 1,
wherein the pressure relaxation structure is a void portion provided on the outer circumferential side of the cavity to extend in the circumferential direction of the rotor and communicating with the cavity,
the void portion is formed by providing a groove in the seal ring, the groove having a convergent shape toward the cavity side in cross-section, and
the void portion and the cavity communicate with each other through a slit which is formed at the convergent portion of the groove to extend in the circumferential direction of the rotor.

8. Turbomachinery comprising:
a rotor including a rotating shaft and moving blades secured to the rotating shaft;
a stator including a rotor casing and stator vanes secured to the rotor casing, the stator encircling the rotor;
a labyrinth seal including a seal ring installed between the rotor and the stator and secured to the stator, and a plurality of seal fins installed on the seal ring in an axial direction of the rotor so as to project in a radial direction of the rotor, the labyrinth seal forming ring-like cavities between the respective seal fins provided in the axial direction of the rotor;
wherein the labyrinth seal is provided with a pressure relaxation structure for allowing a leakage flow to temporarily escape out of the cavity toward an outer circumferential side of the cavity in a circumferential direction of the rotating shaft.

9. The turbomachinery according to claim 8,
wherein the pressure relaxation structure is a void portion provided on the outer circumferential side of the cavity so as to extend in the circumferential direction of the rotor and communicating with the cavity at a plurality of positions spaced circumferentially apart from each other.

10. The turbomachinery according to claim 9,
wherein the void portion is formed of a groove provided in an inner circumferential surface of the seal ring at a bottom position of the cavity and a plate provided at the bottom of the cavity to block an opening portion of the groove, and
the plate is provided with communicating means along the circumferential direction of the rotor, the communicating means allowing the cavity and the void portion to communicate with each other.

11. The turbomachinery according to claim 10,
wherein the communicating means is a plurality of through-holes provided along the circumferential direction of the rotor, and
the through-holes are circumferentially arranged at regular intervals.

12. The turbomachinery according to claim 11,
wherein the cavities are provided a plurality of numbers in the axial direction of the rotor,
the void portion is provided on the outer circumferential side of each of the cavities provided in the axial direction of the rotor, and
positions of the through-holes provided in the plate for each of the cavities are arranged in a coordinate phase in the circumferential direction.

13. The turbomachinery according to claim 10,
wherein the cavity is formed to have a smaller depth in a horizontal direction of the stator than in a vertical direction of the stator, and
the communicating means is through-holes that are provided more in the horizontal direction than in the vertical direction.

14. The turbo-machinery according to claim 8,
wherein the pressure relaxation structure is a void portion provided on the outer circumferential side of the cavity to extend in the circumferential direction of the rotor and communicating with the cavity,
the void portion is formed by providing a groove in the seal ring, the groove having a convergent shape toward the cavity side in cross-section, and
the void portion and the cavity communicate with each other through a slit which is formed at the convergent portion of the groove to extend in the circumferential direction of the rotor.
